(19) United States
(12) Patent Application Publication
(10) Pub. No.: US 2008/0184866 A1
(43) Pub. Date: Aug. 7, 2008

(54) Collapsible and adjustable stand for a musical instrument

(76) Inventor: Wu-Hong Hsieh, Lu Chou City (TW)

Correspondence Address: POSZ LAW GROUP, PLC, 12040 SOUTH LAKES DRIVE, SUITE 101, RESTON, VA, 20191, US

(21) Appl. No.: 12/078,073

(22) Filed: Mar. 27, 2008

Related U.S. Application Data
(63) Continuation-in-part of application No. 11/043,154, filed on Jan. 27, 2005.

(51) Int. Cl. G10G 5/00

(52) U.S. Cl. 84/327

(57) ABSTRACT

A collapsible and adjustable stand for a musical instrument has a rod and a holder. The rod has an upper seat pivotally mounted on a top end thereof, a V-like head mounted on the upper seat, a slot defined in a middle portion thereof, a lower seat slidably mounted in the slot, a bracket mounted on the lower seat, a channel defined at a lower end thereof and a pin slidably received in the channel. The holder has a first end pivotally mounted on the lower end of the rod, a notch defined in the first end for positioning the pin in the notch in the unfolded status, a first leg pivotally mounted on a second end of the holder, two joints mounted on two lateral sides of the holder and each having a second leg pivotally mounted on the joint.

The present invention application is a continuation-in-part application claiming the benefit of U.S. patent application Ser. No. 11/043,154 filed on Jan. 27, 2005.

### BACKGROUND OF THE INVENTION

1. Field of the Invention

The present invention relates to a collapsible and adjustable stand for a musical instrument, and more particularly to a stand which can be folded for storage and can be adjusted in height for accommodating a variety of musical instruments of different sizes such as a saxophone and a guitar.

2. Description of Related Art

With reference to FIG. 6, a stand for a saxophone comprises a rod (60), a V-like head (61) on a top end of the rod (60), an arcuate bracket (62) mounted under the V-like head (61), a holder (63) on a lower end of the rod (60) and multiple legs (64) laterally extending outwards from the holder (63). The legs (64) can be folded downwardly to become parallel to the rod (60).

With reference to FIG. 7, a stand for a guitar comprises a rod (70), a V-like head (71) on a top end of the rod (70), a T-like bracket (72) mounted under the V-like head (71), a holder (73) on a lower end of the rod (70) and multiple shafts (74) laterally extending outwards from the holder (73). The configurations of the stand for the saxophone and that for the guitar are similar except that the rod (60) of the former is shorter than that of the latter. Furthermore, the arcuate bracket (62) is used to support a lower end of the saxophone and the T-like bracket (72) is used to support a main body of the guitar.

In use, the arcuate bracket (62) and T-like bracket (72) are respectively and immovably mounted on the rods (60, 70) so that the heights of the rods (60, 70) can not be adjusted. Furthermore, although the legs (64, 74) can be folded downwardly, the stand for the saxophone or the stand for the guitar still occupies too much space in storage.

Therefore, the invention provides a collapsible and adjustable stand for a musical instrument to mitigate or obviate the aforementioned problems.

### SUMMARY OF THE INVENTION

The main objective of the present invention is to provide a collapsible and adjustable stand for a musical instrument of which a bracket can be adjusted in height to support a variety of musical instruments of different sizes such as a saxophone, a guitar etc.

A further objective of the present invention is to provide the collapsible and adjustable stand for the musical instrument, wherein legs can be folded upwardly thereby reducing storage space required.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a collapsible and adjustable stand for a musical instrument in accordance with the present invention and being in an unfolded status;

FIG. 2 is a perspective view of the collapsible and adjustable stand for a musical instrument in accordance with the present invention and in a folded status;

FIG. 3 is a schematic view showing a folding procedure of the collapsible and adjustable stand for a musical instrument in accordance with the present invention;

FIG. 4 is a perspective view of the collapsible and adjustable stand for a musical instrument in accordance with the present invention supporting a saxophone;

FIG. 5 is a perspective view of the collapsible and adjustable stand for a musical instrument in accordance with the present invention supporting a guitar;

FIG. 6 is a perspective view of a conventional stand for supporting the guitar; and

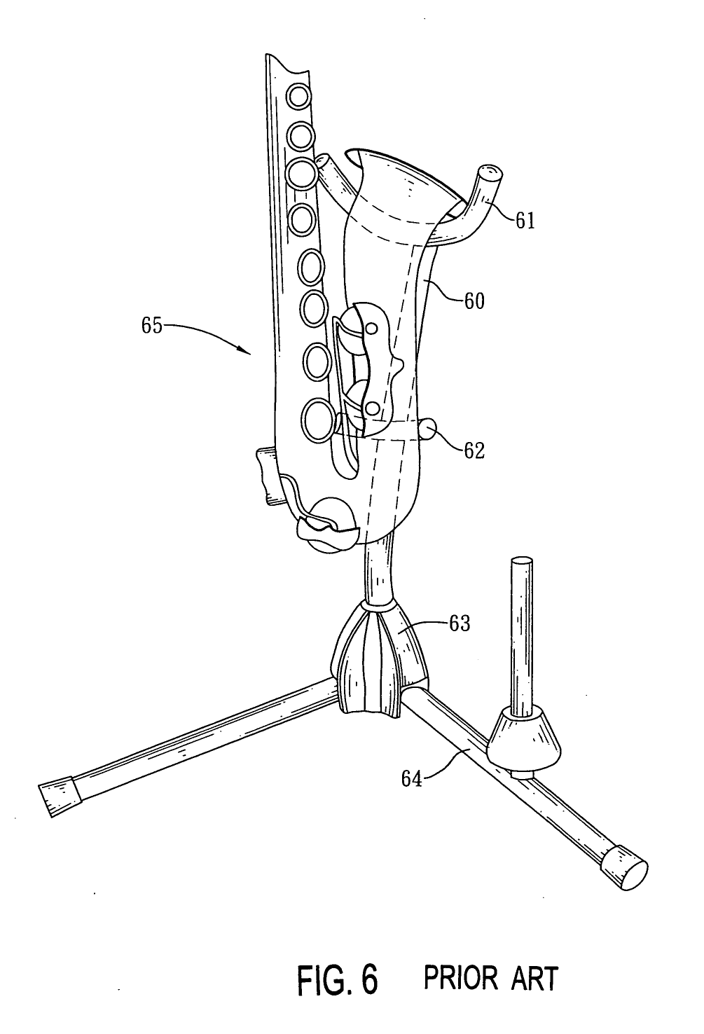

FIG. 7 is a perspective view of another conventional stand for supporting a saxophone.

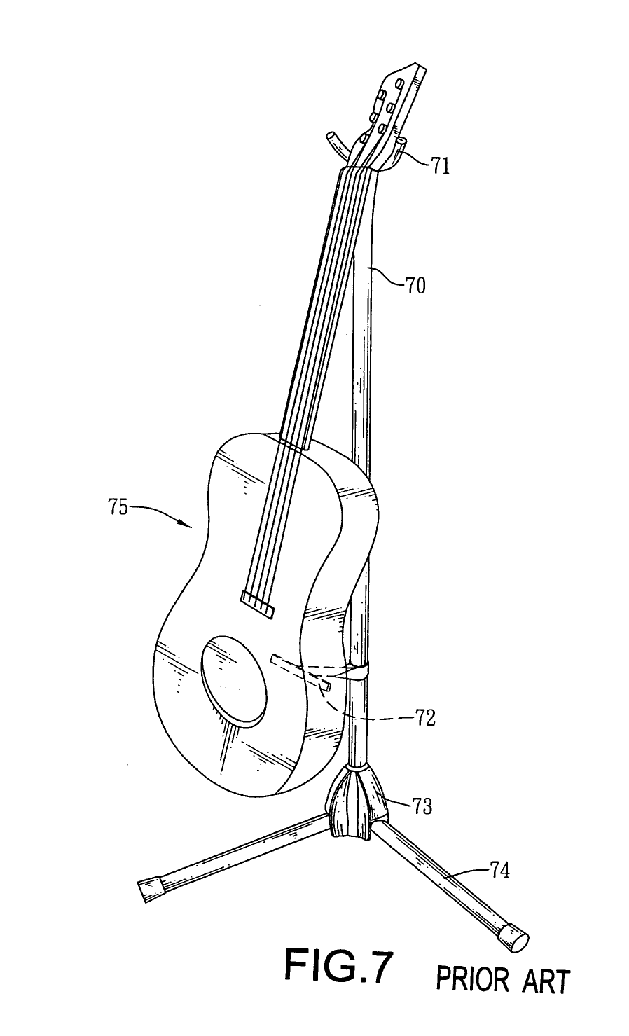

### DETAILED DESCRIPTION OF THE PREFERRED EMBODIMENT

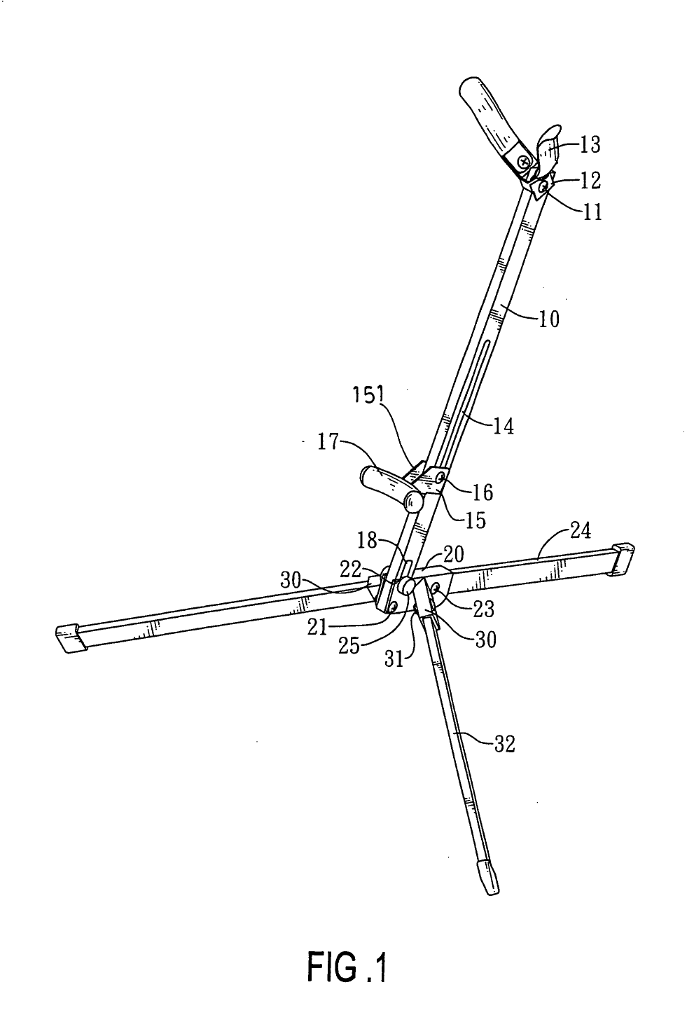

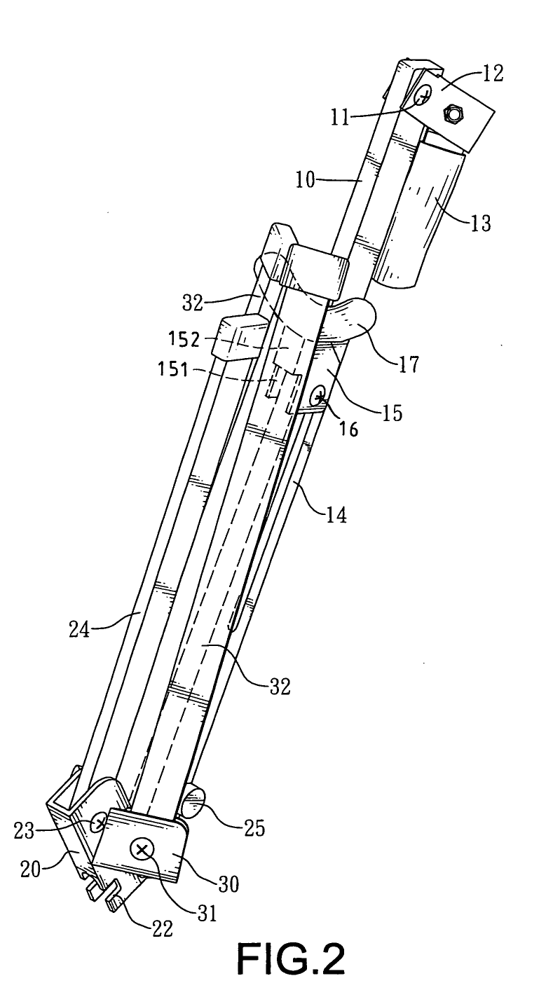

With reference to FIGS. 1-3, a collapsible and adjustable stand for a musical instrument comprises a rod (10) and a holder (20).

The rod (10) has two opposite sides.

An upper seat (12) is mounted pivotally on a top end of the rod (10) with a first fastener (11).

A V-like head (13) is mounted on the upper seat (12) thereby supporting a top end of the musical instrument. An elongated hole or slot (14) extends through and along a middle portion of the rod (10).

A lower seat (15) is mounted pivotally on the rod (10). As a result, the lower seat (15) selectively slides along the elongated hole or slot (14) and be positioned in the elongated hole or slot (14) via a second fastener (16) that is mounted through the elongated hole or slot (14) and the lower seat (15).

The second fastener (16) may be a screw and selectively screws tightly through the lower seat (15) and presses the lower seat (15) tightly against the rod (10) without sliding.

The lower seat (15) may have two wings (151) and a positioning tab (152). The wings (151) are mounted pivotally on the rod (10), respectively abut the sides of the rod (10) and are mounted slidably along the elongated hole (14). The second fastener (16) extends through the wings (151) and selectively presses the wings (151) tightly against the sides of the rod (10) respectively. The positioning tab (152) is formed between and connected perpendicularly to the wings (151) and selectively presses against the rod (10) to prevent the lower seat (15) from sliding and hold the lower seat (15) at a specific position on the rod (10). A friction from the gravity of the musical instrument between the positioning tab (152) and the rod (10) strongly keeps the musical instrument on the lower seat (15) from inadvertently sliding along the rod (10). Therefore, the positioning tab (152) may easily and quickly hold the lower seat (15) and the musical instrument on a specific position on the rod (10) without spending time tightening the second fastener (16). When a user finally sets a suitable position of the lower seat (15) held by the positioning tab (10) for the musical instrument after repeatedly adjusting the lower seat (15), he/she can further tighten the second fastener (16) to tightly hold the lower seat (15) on the rod (10).

A bracket (17) is mounted on the lower seat (15). A channel (18) is defined longitudinally in a lower end of the rod (10) and a pin (25) is slidably mounted in the channel (18).

The holder (20) has a first end pivotally mounted on the lower end of the rod (10) by a first pivot pin (21), and a first leg (24) pivotally mounted at a second end thereof by a second pivot pin (23). Two joints (30) are mounted pivotally on two lateral sides of the holder (20). Two second legs (32) are respectively and pivotally mounted on the joints (30) by a third pivot pin (31). A notch (22) is defined at a top end of the holder (20) so that the pin (25) can be positioned in the notch (22) when the first and the second legs (24, 32) are unfolded.

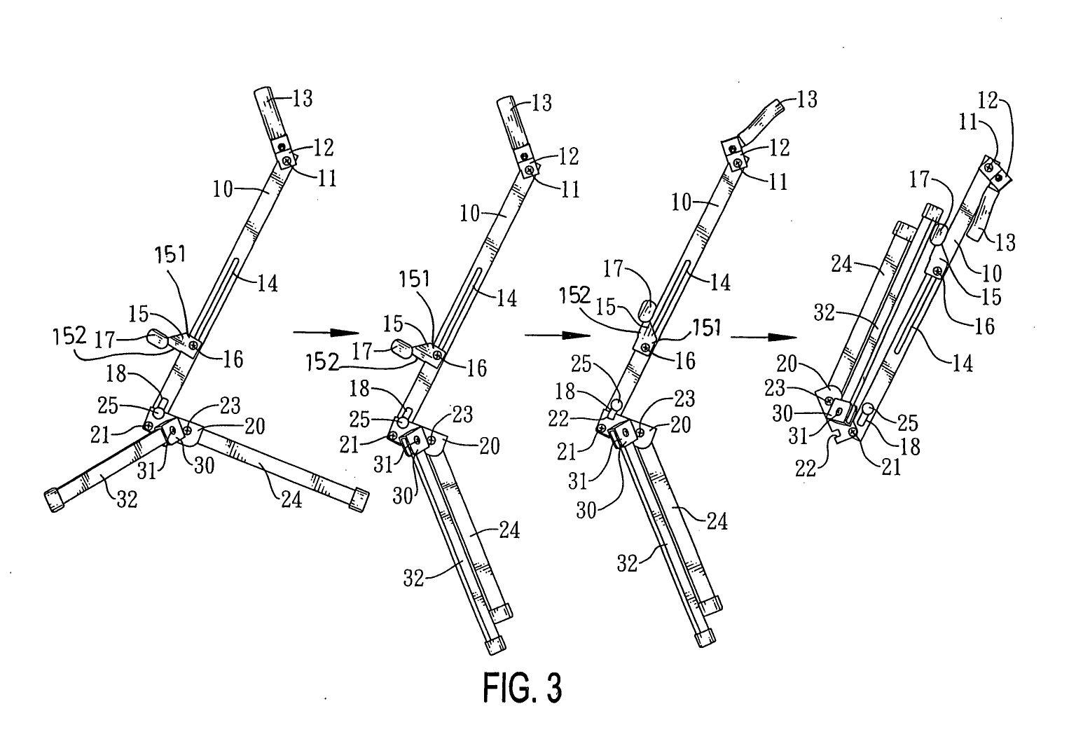

With reference to FIG. 3, in a folding procedure, the first and the second legs (24, 32) are pivoted and put together. Then the holder (20) is pivoted upwardly about the first pivot pin (21) so that the first and the second legs (24, 32) are abutted against the rod (10). Furthermore, the lower seat (15) is pivoted upwards by loosening the second fastener (16) whereby the bracket (17) abuts the rod (10). The upper seat (12) is pivoted upwards by loosening the abutment of the first fastener (11) to the V-like head (13) against the rod (10). Therefore, the collapsible and adjustable stand for the musical instrument has a compact size for storage.

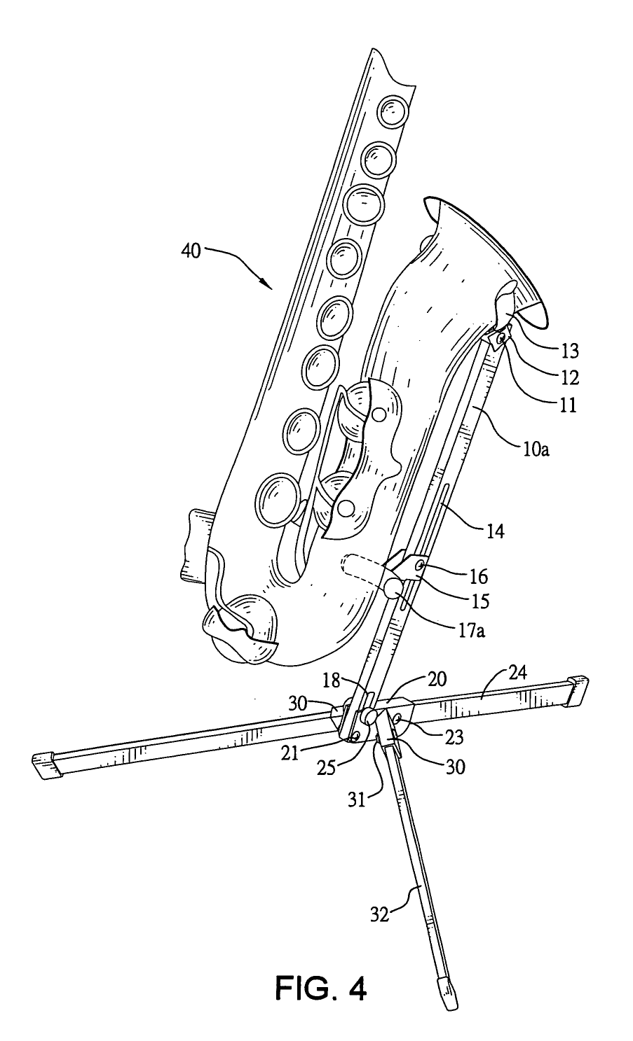

With reference to FIG. 4, for supporting a saxophone, the rod (10a) of the stand in accordance with the invention is short to correspond to the length of the saxophone and the bracket (17a) is formed with an arcuate shape to support an arcuate body of the saxophone and a top end of the saxophone is leaned against the V-like head (13) so that the saxophone can be steadily supported on the collapsible and adjustable stand for a musical instrument. With adjustment of the height of the lower seat (15) by loosening the second fastener (16), the height of the bracket (17a) can be adjusted so that saxophones with a variety of styles can be supported on the collapsible and adjustable stand.

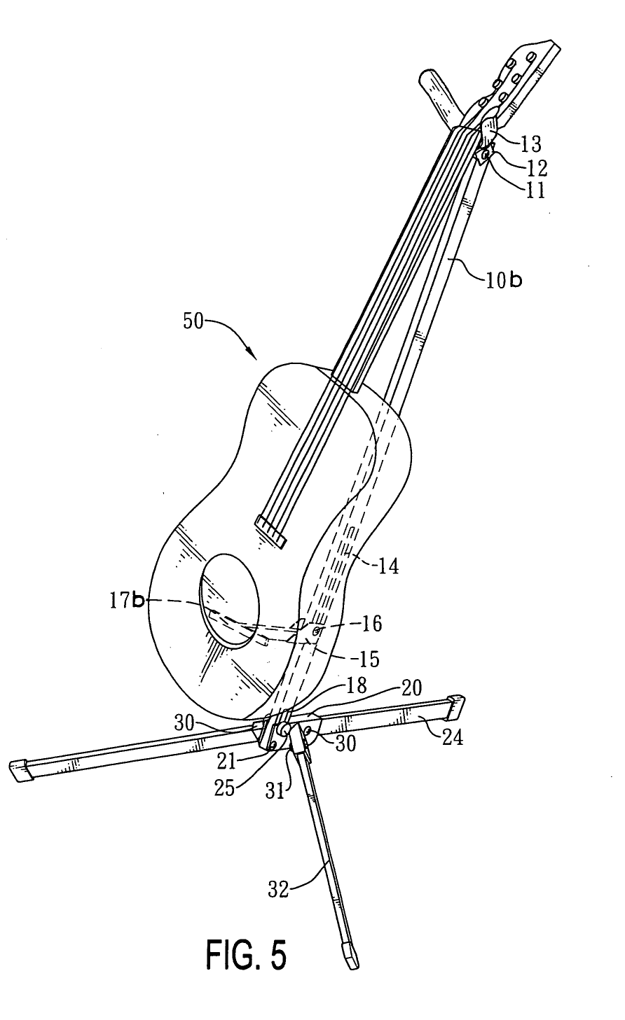

With reference to FIG. 5, for supporting a guitar, the rod (10b) of the stand is of sufficient length to correspond to that of the guitar and the bracket (17b) has a T-like shape for supporting a flat body of the guitar. A top end of the guitar is leaned against the V-like head so that the guitar can be steadily supported on the collapsible and adjustable stand for a musical instrument. With adjustment of the height of the lower seat (15) by loosening the second fastener (16), the height of the bracket (17b) can be adjusted so that guitars with a variety of styles can be supported on the collapsible and adjustable stand.

Additionally, the first fastener (11), the first, second and third pivot pins (21, 23, 31) can be rivets or bolts with nuts, and the second fastener (16) can be replaced with a bolt with a nut.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A collapsible and adjustable stand for a musical instrument comprising:
a rod (10) having
two opposite sides;
an upper seat (12) mounted pivotally on a top end of the rod;
a V-shaped head (13) mounted on the upper seat (12);
an elongated hole (14) extending through and along a middle portion of the rod (10);
a lower seat (15) mounted pivotally on the rod (10) and selectively sliding along the elongated hole (14) in the rod (10) via a fastener (16) mounted through the elongated hole (14) and the lower seat (15), the lower seat (15) having
two wings (151) mounted pivotally on the rod (10), respectively abutting the sides of the rod (10) and mounted slidably along the elongated hole (14); and
a positioning tab (152) formed between and connected perpendicularly to the wings (151) and selectively pressing against the rod (10) to prevent the lower seat (15) from sliding and hold the lower seat (15) on the rod (10), a bracket (17) mounted on the lower seat (15);
the fastener (16) selectively pressing the lower seat (15) tightly against the rod (10), extending through the wings (151) and selectively pressing the wings (151) tightly against the sides of the rod (10) respectively;
the lower seat (15), fastener (16) and bracket (17) sliding along a length of the elongated hole (14) in the rod (10);
a channel (18) defined longitudinally in a lower end of the rod (10) and a pin (25) slidably inserted in the channel (18);
a holder (20) having a first end mounted pivotally on the lower end of the rod (10), a notch (22) defined in the first end for positioning the pin (25) in the notch (22) in the unfolded status, a first leg (24) pivotally mounted on a second end of the holder (20), two joints (30) mounted on two lateral sides of the holder (20) and each having a second leg (32) pivotally mounted on the joint (30).

2. The collapsible and adjusted stand for a musical instrument as claimed in claim 1, wherein the bracket (17a) is formed with an arcuate shape.

3. The collapsible and adjusted stand for a musical instrument as claimed in claim 1, wherein the bracket (17b) is has a T-shape.

4. The collapsible and adjusted stand for a musical instrument as claimed in claim 1, wherein the fastener is a screw.
